(19) United States
(12) Patent Application Publication
(10) Pub. No.: US 2019/0226259 A1
(43) Pub. Date: Jul. 25, 2019

(54) HINGE DEVICE WITH DAMPING OF THE TERMINAL PORTION OF THE CLOSING STROKE

(71) Applicant: C.M.I. CERNIERE MECCANICHE INDUSTRIALI S.R.L., Loc. Crespellano (IT)

(72) Inventor: Eros Gherardi, Bologna (IT)

(21) Appl. No.: 16/329,105

(22) PCT Filed: Aug. 23, 2017
(86) PCT No.: PCT/EP2017/071208

§ 371 Date: Feb. 27, 2019

(30) Foreign Application Priority Data
Aug. 31, 2016 (IT) 102016000088717

(51) Int. Cl. E05F 1/12; E05F 5/02

(52) U.S. Cl. CPC E05F 1/1261; E05F 5/02; E05Y 2201/256; E05Y 2900/304; E05Y 2201/412; E05Y 2201/71; E05Y 2900/308; E05Y 2201/264

(57) ABSTRACT

A hinge device (1) damps the terminal portion of the closing stroke of a door of an appliance and has a first connection (3) fixed to a frame of the appliance and pivotally connected by a pivot hinge (4) to a second connection (5) fixed to the door to allow a stroke between opening and the closing. The device (1) includes:
a motion damping mechanism (15) having a portion (16) fixed to the first connection (3) and a mobile portion (17);
a kinematic transmission mechanism (20) kinematically connecting the first rack means (9) to the mobile portion (17) of the damping mechanism (15 to transmit the motion induced in the first rack means (9) by matching with a portion (11) of the second connection means (5) in the terminal portion of the closing stroke to the damping means (15) which slows down the speed of this motion.

### BACKGROUND

The present invention relates to the field concerning household appliances and furniture and it refers to a hinge device with damping of the terminal portion of the closing stroke particularly suitable for a household appliance, such as an oven, a dishwasher or the like or to a piece of furniture having a door or shutter with horizontal and lower rotation axis.

Hereinafter in the present document, with the term “stroke” for example opening or closure stroke, it is meant the rotation of a member of the hinge device around a rotation pin of the device itself with contemporary and identical rotation of a door or shutter of the household appliance where such door is fixed to said member; the stroke is therefore to be intended as and understood to be circular and centred on said pin.

Hinge devices for oven are known, said devices exerting a considerable closure force to guarantee the seal and the closure of the oven in the terminal portion of the closing stroke.

Hinge devices for dishwashers, for doors or pieces of furniture are also known, said devices can reach high angular closure speeds even if closed with strong energy.

A disadvantage of such known hinge devices consists in the fact that if someone does not follow through the closure of the door or shutter with the hand, such door can hit the body of the household appliance or of the piece of furniture causing noise, wear, risk of damages and injuries with regard to the people standing in the trajectory of the closure of the door or shutter. Another disadvantage of such known hinge devices consists in the fact that, without controlling and not slowing down the closure speed of the door or shutter, they provide the user with an unfavorable impression or an idea of weak strength apart from the real quality of the device.

Documents n. DE 10 2009 022737 A1 and n. AT 7 597 U1 disclose a hinge provided with many features that resemble those disclosed herein.

### SUMMARY

An aim of the present invention is to propose a hinge device to reduce the excess of speed of the door in the terminal portion of its closing stroke.

Another aim is to propose a hinge device to transfer nearly all of its elastic closure force having nearly the same static and almost static friction of a corresponding known hinge device.

Further aim is to propose a hinge device which can be shaped to obtain bulks and defined soften effects.

Another aim is to provide a hinge device whose soften effect is adjustable by means of replacement of few parts.

### BRIEF DESCRIPTION OF THE DRAWINGS

The features of the invention are underlined below with particular reference to the enclosed drawings in which:

FIGS. 1 and 2 show axonometric views, represented from the respective and opposed points of view, of the hinge device with damping of the terminal portion of the closing stroke, object of the present invention, in a partial opening condition;

FIGS. 3, 4, 5, 6, and 7 show views from the same side of the device of FIG. 1 in conditions of progressive closure;

FIGS. 8, 9, and 10 show views from the same side of the device of FIG. 2 in conditions of progressive closure;

FIGS. 11 and 12 show enlarged views and from respective sides of a detail of the preceding figures;

FIG. 13 shows an axonometric view of a transmission kinematic mechanism of the preceding figures, extracted from the device itself;

FIG. 14 shows an axonometric view of the device of FIG. 1 sectioned from a cross plane;

FIGS. 15 and 16 show respective axonometric view and longitudinally sectioned view of a transmission shaft of the device of the preceding figures and underlined in FIGS. 13 and 14;

FIGS. 17 and 18 show respective frontal and rear views of some details of FIG. 1;

FIG. 19 shows an axonometric view of a first variant of the device of FIG. 1, in a condition of partial opening;

FIGS. 20 and 21 show orthogonal projection views of the variant of the device of FIG. 19 in conditions respectively partially opened and closed;

FIG. 22 shows the device of FIG. 21 sectioned from a middle longitudinal plane;

FIG. 23 shows an axonometric view of a second variant of the device of FIG. 1, in a condition of partial opening;

FIG. 24 shows an orthogonal projection view of the variant of the device of FIG. 23 in an almost closed condition;

FIG. 25 shows an axonometric view of a transmission kinematic mechanism of the second variant of the device, extracted from the device itself;

FIG. 26 shows an enlarged view and in orthogonal projection of a detail of FIG. 24.

### DETAILED DESCRIPTION

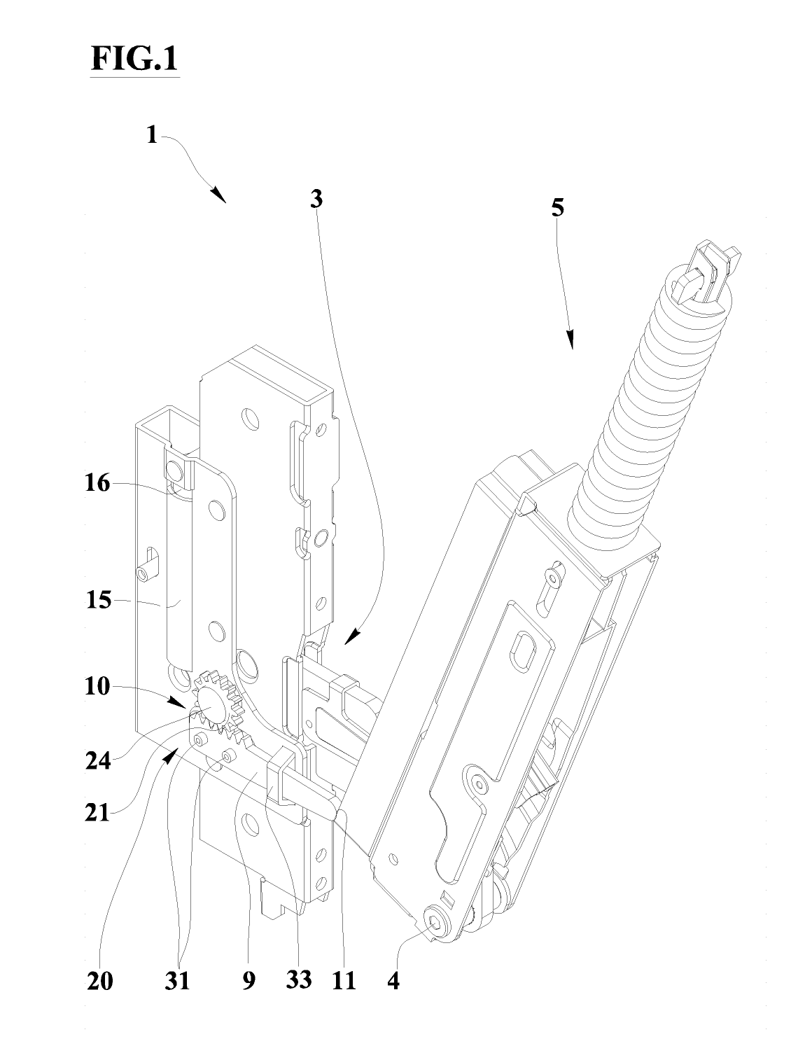

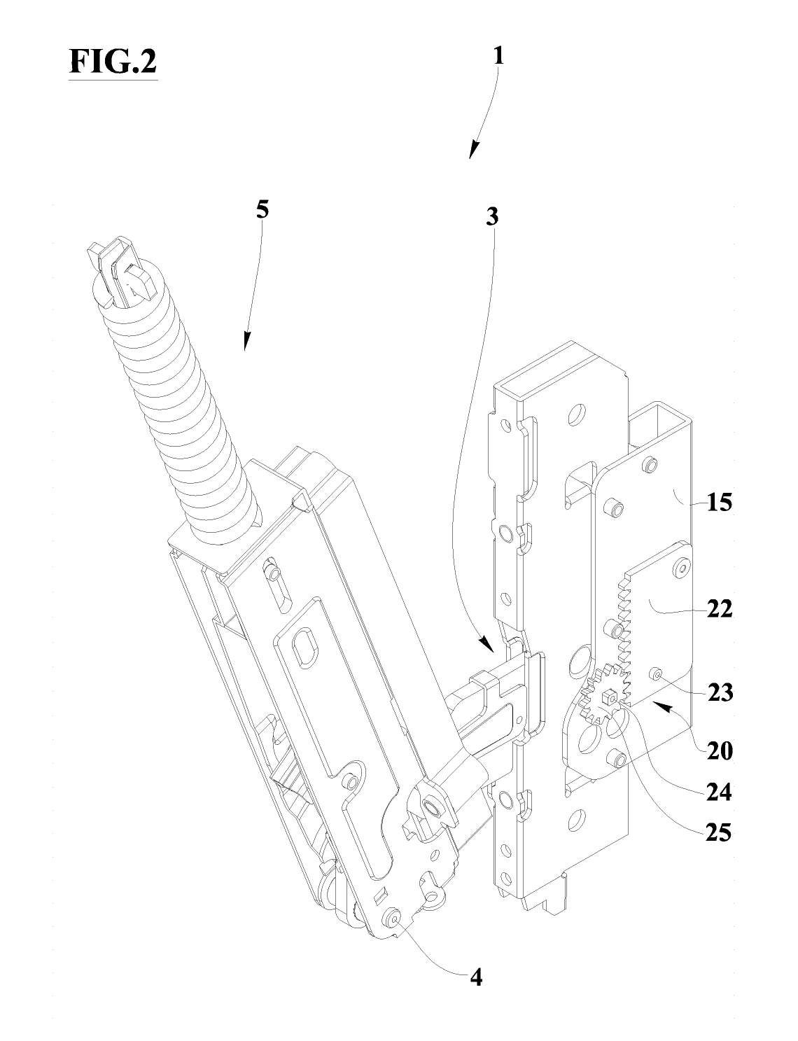

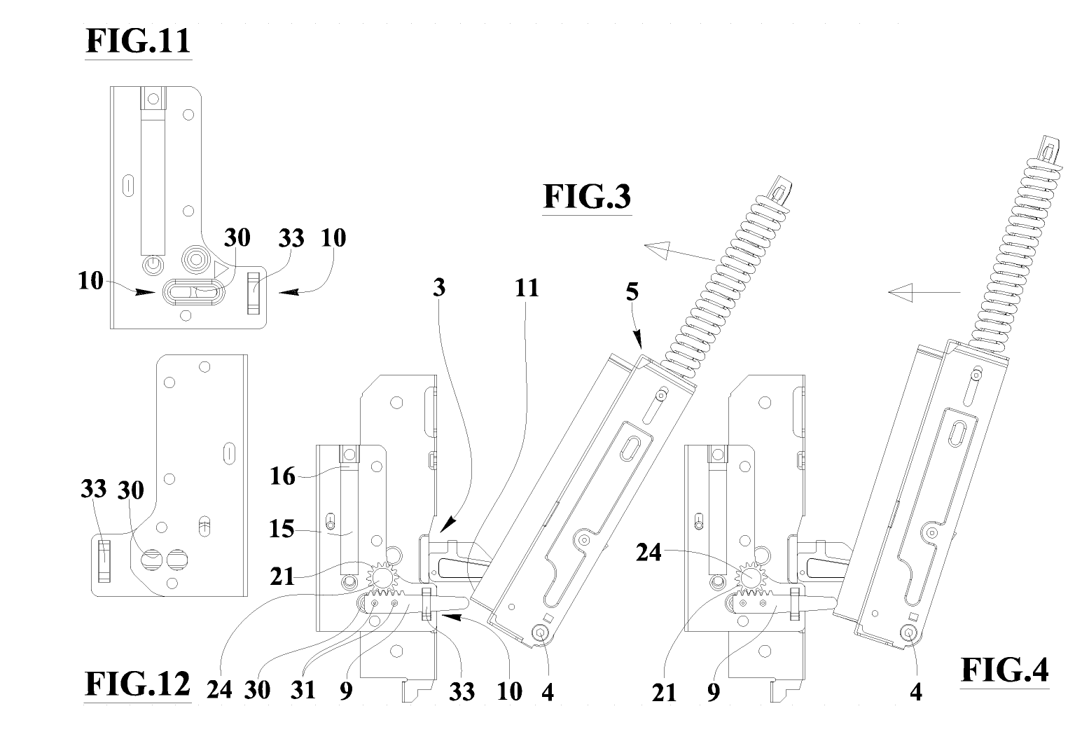

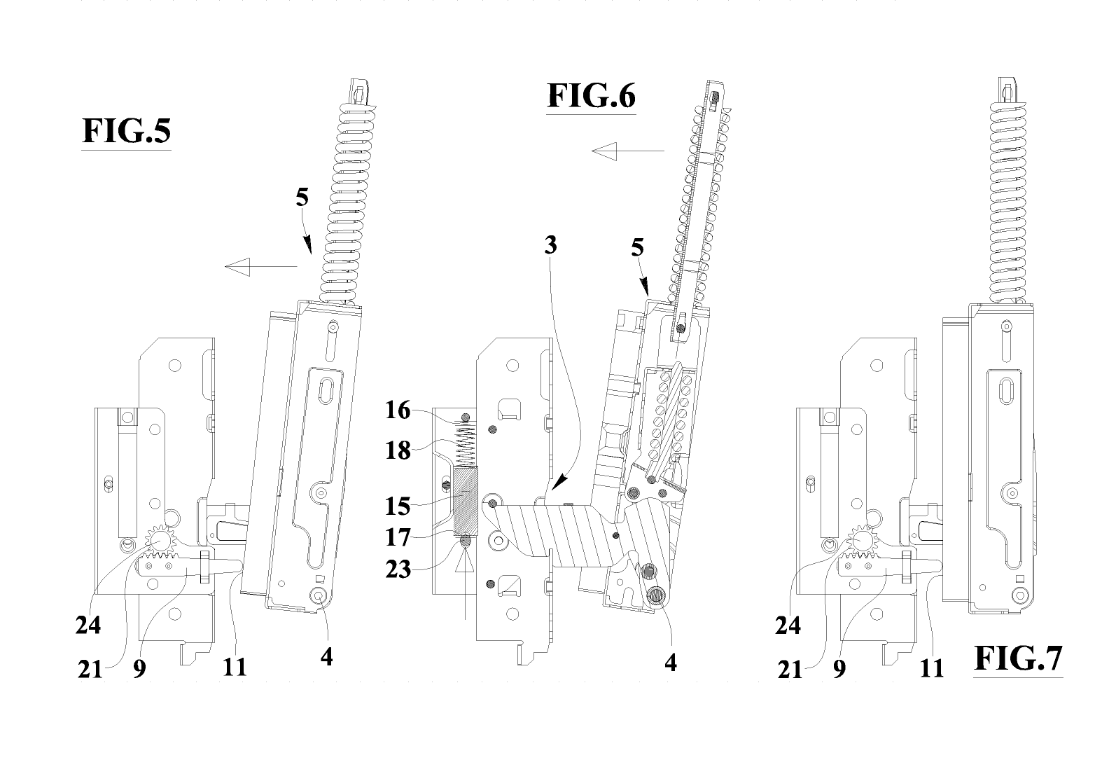

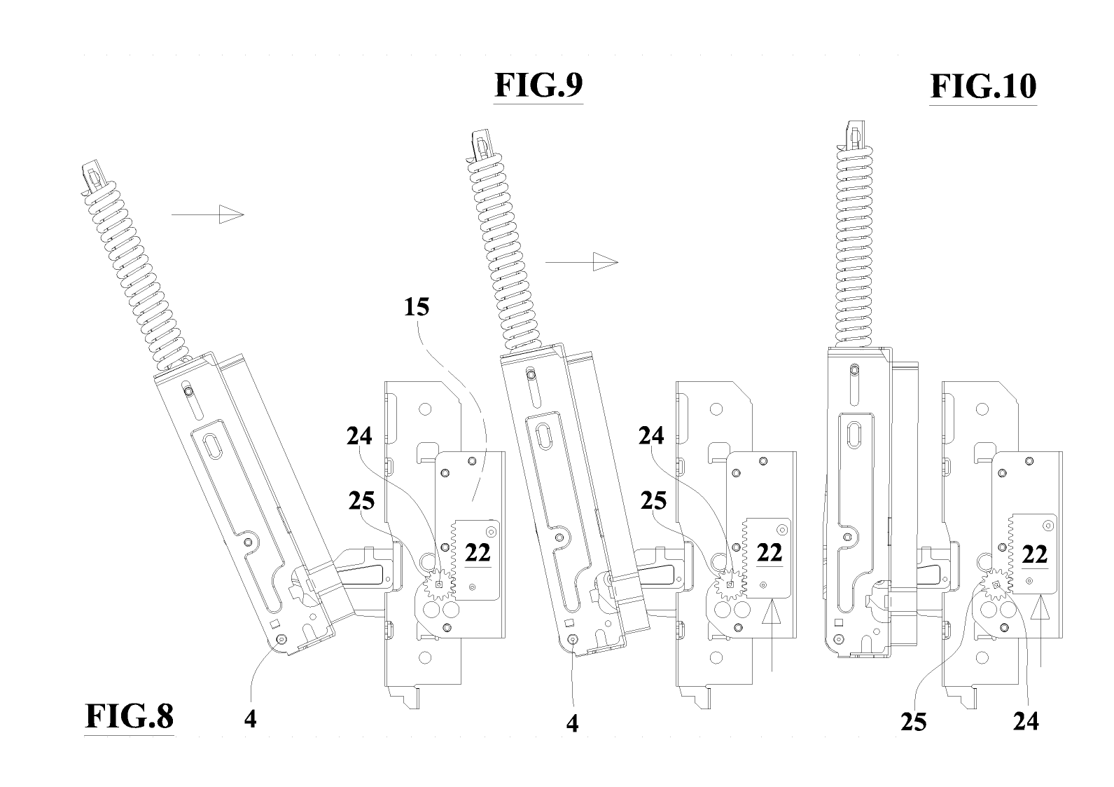

With reference to FIGS. 1-18, numeral 1 indicates the hinge device with damping of the terminal portion of the closing stroke, to illustrate how to carry out the aims of the present invention in the context of several embodiments.

The hinge device with damping of the terminal portion of the closing stroke is provided with a first connection means 3 assigned to be fixed to a structure or frame of an appliance, piece of furniture or the like and it 3 is connected in a rotating way by means of a pivot hinge 4 to a second connection means 5 assigned to be fixed to a door, hatch or shutter of said appliance or piece of furniture to allow the strokes of the door or hatch between opening and closure conditions and vice versa.

Said device 1 comprises at least:
a first rack means 9 sliding into first guide means 10 of the first connection means 3 and facing to a portion 11 of the second connection means 5 which, at least in said terminal portion of the closure stroke, it approaches the first connection means 3;
a motion damping means 15 having a portion 16 fixed to the first connection means 3 and a mobile portion 17;
a kinematic transmission mechanism 20 which connects in a kinematic way the first rack means 9 to the motion damping means 15.

When the door and the second connection means 5 reach a predetermined angular distance of the closed condition, in correspondence with which the terminal closing stroke, said portion 11 matches in a sliding way with an end of said first rack means 9, moving it so as to translate it so as to slide in a direction corresponding to its longitudinal axis during such terminal closing stroke so that the translating in the sliding direction of the first rack means 9 has the effect of a translation into the first guide means 10. Thus the sliding direction determined by the first guide means 10 is parallel or coaxial with respect to the longitudinal axis of the first rack means 9.

The sliding direction of the first rack means 9, being determined by the guide means 10, is fixed with respect to the first connection means 3 and, for example, can be substantially horizontal or almost horizontal. The motion direction of the portion 11 of the second connection means 5 is tangent, in the instantaneous contact point between said portion 11 of the second connection means 5 and the first rack means 9, to a circumference which is centred on the pivot hinge 4 and passing through said instantaneous contact point.

Such sliding in the direction corresponding to the longitudinal axis of the first rack means 9 during the terminal closing stroke and the motion direction of the portion 11 form interposed angles lower than 90°, preferably lower than 70°-80°.

The distance of the sliding axis of the first rack means 9 from the pivot hinge 4 and/or said predetermined angular distance are determined according to the length of the stroke to give to the first rack means 9, the size of the forces to transfer, and in general according to the desired features of the device, and preferably they are comprised between 1 and 10 times the translation stroke of the first rack means and ranging 45°-20°.

Said kinematic transmission mechanism 20 transfers to the mobile portion 17 of the motion damping means 15 the motion of the first rack means 9, caused by the matching between the portion 11 of the second connection means 5 and the first rack means 9 in the terminal portion of the closing stroke so as to slow down the speed of such motion.

The device 1 comprises resilient means 18 acting in repulsion between the portions fixed 16 and mobile 17 of the motion damping means 15 and assigned at least to the resilient recovery of the mobile portion 17 towards its rest condition during the opening stroke and/or when the first rack means 9 is not in contact with the portion 11.

The size of such resilient means 18, preferably of helical spring type, can be designed to provide also the retrograde motion of the kinematic chain and of the first rack means 9 during the opening stroke.

Said kinematic transmission mechanism 20 interposed between the first rack means 9 and the mobile portion 17 of the motion damping means 15 comprises at least a first pinion means 21 engaged with the first rack means 9 and fixed to an end of a transmission shaft 24 connected to the first connection means 3 in a freely rotatable way around its own axis. On the opposed end of the transmission shaft 24 is fixed a second pinion means 25 engaged with a second rack means 22 which is driven, by means of the transmission shaft 24 and the second pinion means 25, by the first pinion means 21.

The second rack means 22 is connected to the first connection means 3 in a freely sliding way parallel to the longitudinal axis of the motion damping means 15 of linear piston or syringe type housed in a box-shaped portion of the first connection means 3.

The second rack means 22 is provided with a connection means 23 engaged with, or matching with the mobile portion 17 of the motion damping means 15 to move it 17 in the terminal portion of the closing stroke.

Said ends of the transmission shaft 24 and said pinion means first 21 and second 25 are provided with respective link means of anti-rotation type, for example of polygonal cross section or of key type.

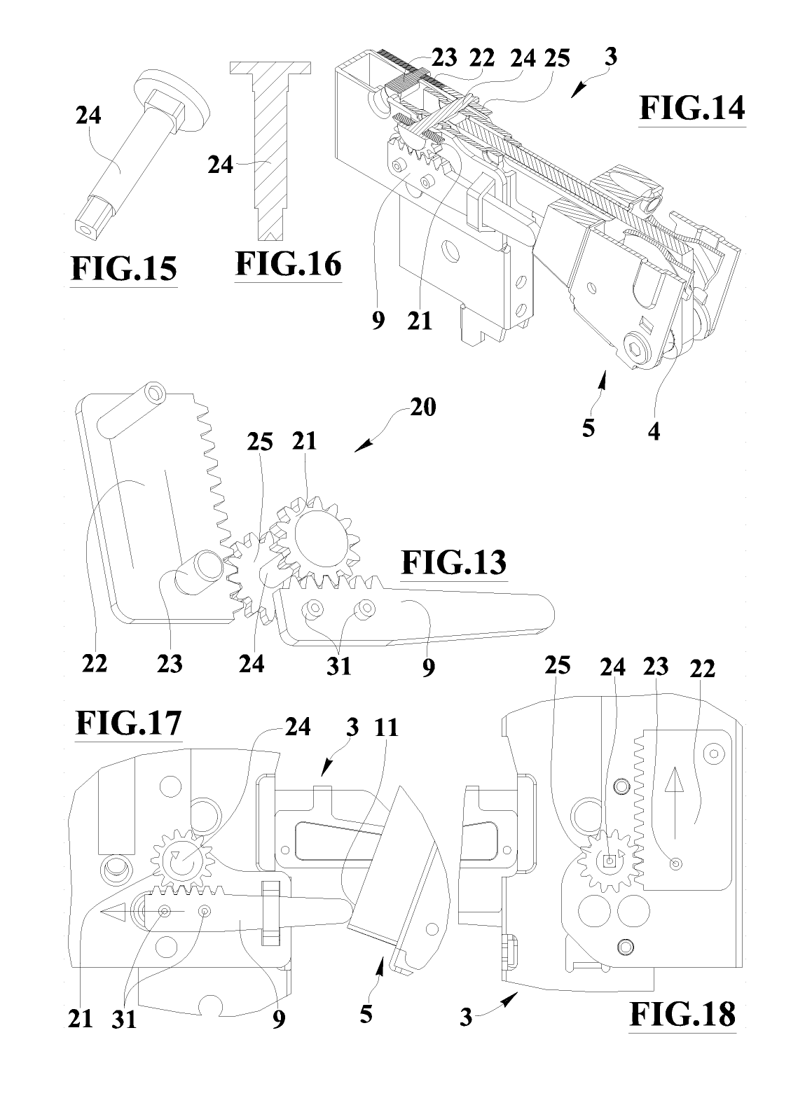

The transmission ratio of said kinematic transmission mechanism 20 depends basically on the ratio between the numbers of teeth of the pinion means first 21 and second 25. In the embodiment of FIGS. 1 and 13, the pinion means first 21 and second 25 have the same number of teeth. The transmission report can be varied replacing the second pinion means 25 of FIG. 13 with another one equipped with a different number of teeth. Obviously such replacement of the second pinion means 25 also requires the replacement of the second rack means 22 with a larger or a more narrow one, but the other features of the device do not change. It is thus possible to modify the motion damping means 15 with another one having different stroke or damping features or to change the features of the terminal damping and in general to adapt the operation of the device for example replacing the second pinion means 25 and the second rack means 22 and/or the motion damping means 15 keeping the remaining parts of the device with the consequent economic and logistic advantages.

The first rack means 9 and the first pinion means 21 are external and adjacent to a first face of the box-shaped portion of the first connection means 3 while the second pinion means 25 and the second rack means 22 are external and adjacent to the second face of the box-shaped portion opposed to the first face.

Said faces first and second delimit the housing for the motion damping means 15 carried out in the box-shaped portion of the first connection means 3.

The first rack means 9 is rectilinear and comprises a toothed sector and an elongated protrusion matching with the portion 11 of the second connection means 5 where such protrusion is aligned with the toothed sector.

The first guide means 10 comprises a first elongated slot 30 carried out in the first connection means 3 aligned to the sliding direction of the first rack means 9 and engaged in a sliding way by a plurality of slide pins 31 fixed to the first rack means 9.

The first guide means 10 can furthermore comprise a tubular means 33 carried out in or fixed to the first connection means 3, with an inner cavity aligned to the sliding direction of the first rack means 9 and engaged in a sliding way by the elongated protrusion of the first rack means 9.

The invention provides that the kinematic connection between the first pinion means 21 and the second rack means 22 can be different from the one of the above described preferred embodiment and that it can use alternative intermediate means or that it can be of a direct type as exemplified in the variants described below.

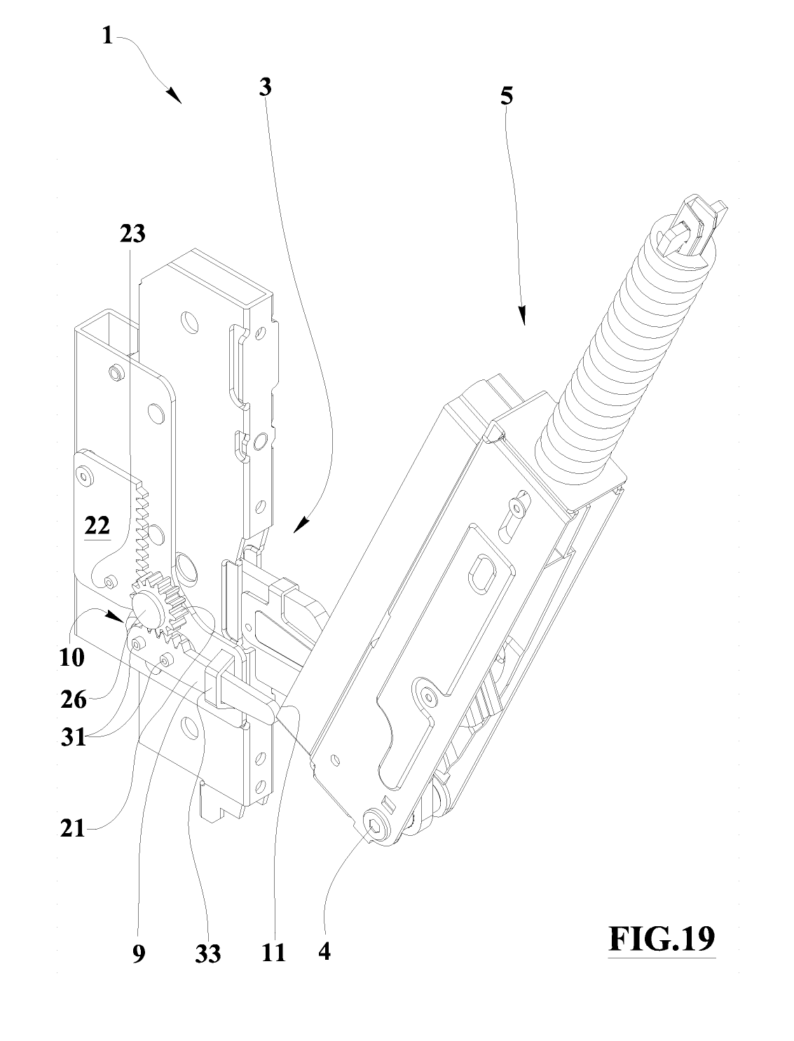

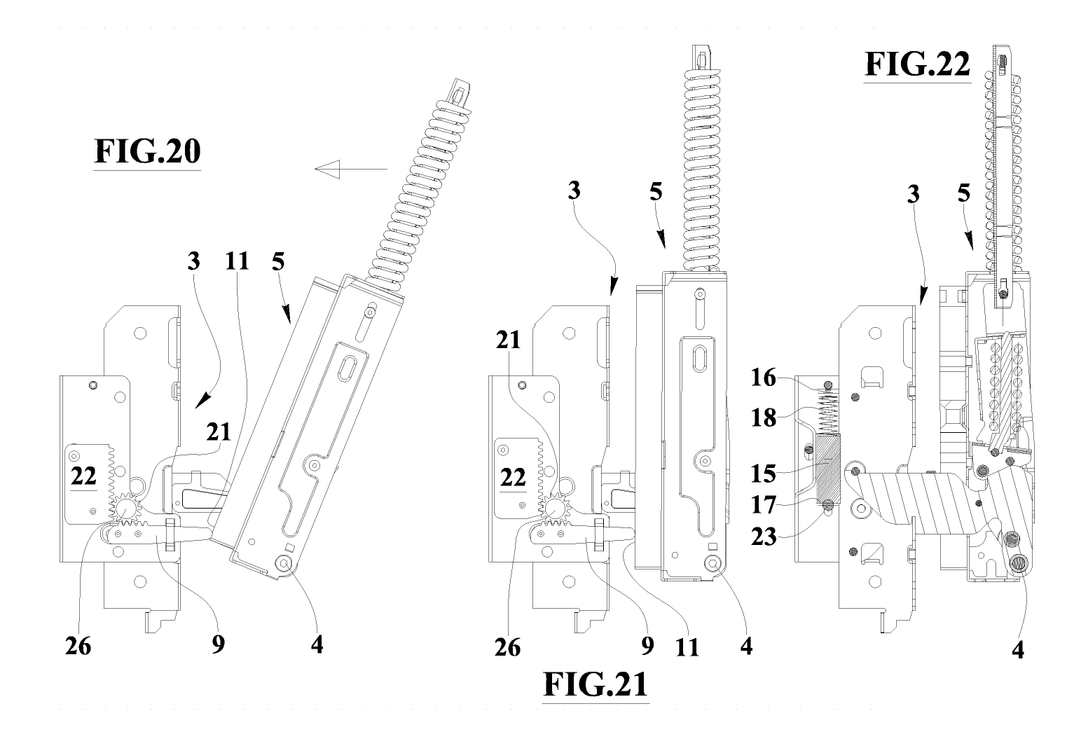

The variant of the device of FIGS. 19-22 differs from the preferred embodiment, described above, because the first pinion means 21 is engaged directly into the second rack means 22.

The first pinion means 21 is fixed to its own rotation pin 26 connected to the first connection means 3 in a freely rotating way around its own axis.

The linear motion damping means 15 lies on the rotation plane of the second connection means 5 and it is oriented parallel to this latter in the closed condition.

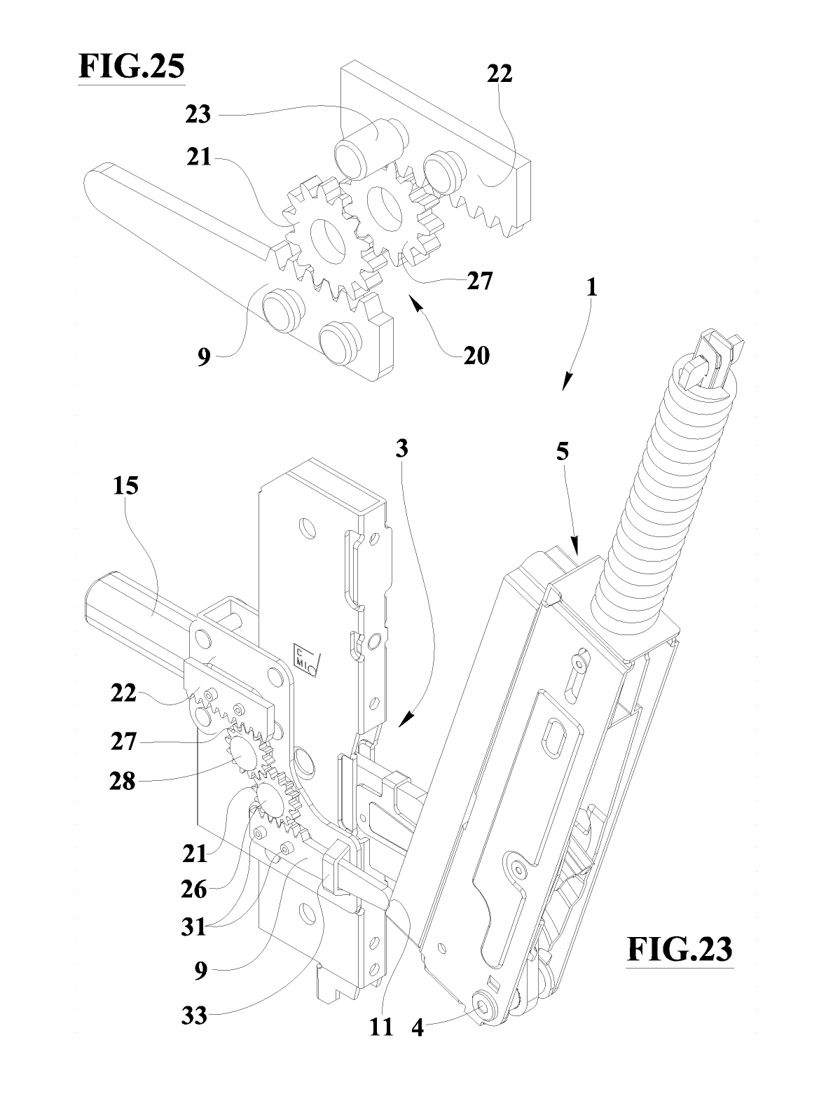

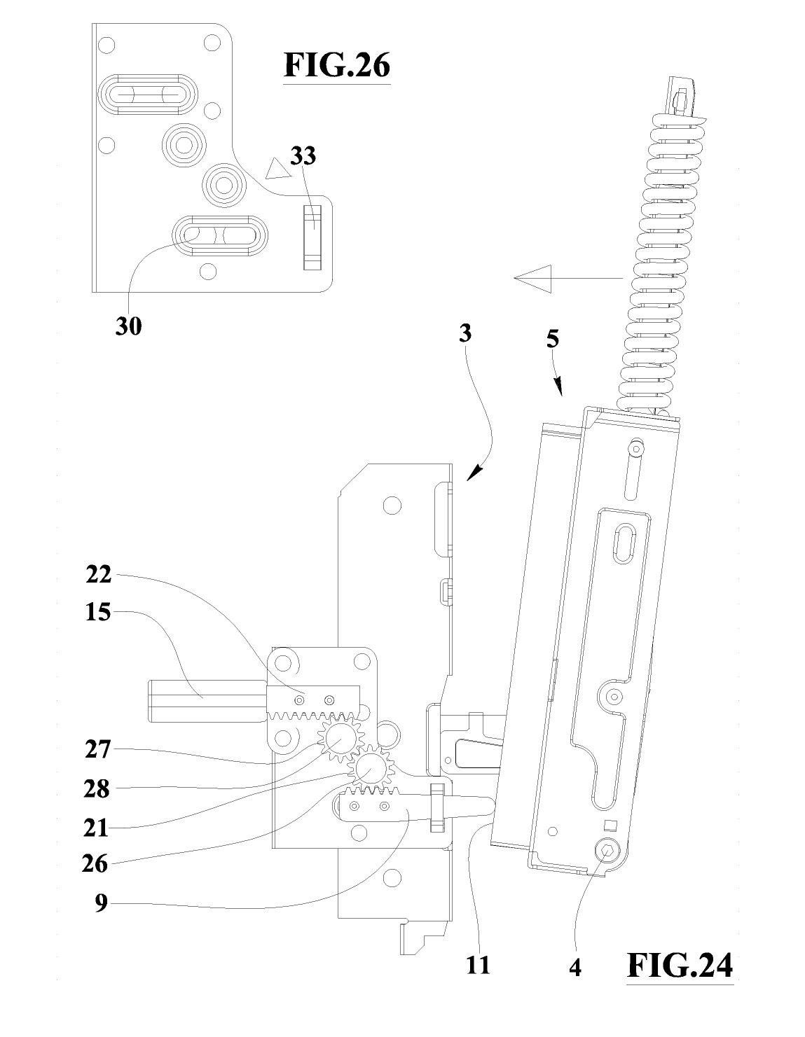

The variant of the device of FIGS. 23-26 differs from the above described embodiments because the first pinion means 21 is fixed to its own freely rotating rotation pin 26 connected to the first connection means 3 and the first pinion means 21 is engaged, besides the first rack means 9, with a third pinion means 27 fixed to its own rotation pin 28 parallel to the pin of the first pinion means and connected to the first connection means 3 in a freely rotating way; such third pinion means 27 is engaged with the second rack means 22. Said first pinion means 21, third pinion means 27, first rack means 9 and second rack means 22 are positioned on the same face of the box-shaped portion of the first connection means 3. The linear motion damping means 15 lies on the rotation plane of the second connection means 5 and it is orthogonally oriented to this latter in the closed condition.

The first connection means 3 of all of the embodiments of the above described invention comprises a part to fix to the body or frame of the household appliance or piece of furniture and made of one or more box-shaped portions and of an arm part, connected to the pivot hinge 4 and fixed in a removable way, also without tools, to the part to fix to the body or frame to allow the detachment from this latter of the door or shutter.

1) A hinge device (1) with damping of a terminal portion of a closing stroke of a hatch or door of an appliance or piece of furniture and having a first connection means (3) configured for fixation to a frame or structure of the appliance or piece of furniture and pivotally connected by means of a pivot hinge (4) to a second connection means (5) configured for fixation to the hatch or door to allow hatch or door to pivot between opening and closing conditions and vice versa; wherein said hinge device (1) comprises at least:
a first rack means (9) sliding with a sliding motion into first guide means (10) of the first connection means (3) and facing a portion (11) of the second connection means (5) that, at least in said end portion of said closing stroke approaches the first connection means (3) matching with one end of said first rack means (9) where the sliding direction of the first rack means (9) into the first guide means (10) forms angles less than 90° with the movement direction of the portion (11) of the second connection means (5) in said terminal portion of the closing stroke;
a motion damping means (15) having a portion (16) fixed to the first connection means (3) and a mobile portion (17);
a kinematic transmission mechanism (20) kinematically connecting the first rack means (9) to the mobile portion (17) of the motion damping means (15);
where said kinematic transmission mechanism (20) transmits the sliding motion induced in the first rack means (9) by matching with the portion (11) of the second connection means (5) in the terminal portion of the closing stroke to the motion damping means (15) which slows down the speed of this sliding motion; said kinematic transmission mechanism (20) comprises at least a first pinion means (21) geared to the first rack means (9) and a second rack means (22) operated by the first pinion means (21) and connected to the first connection means (3) in a freely slidable way and slidable parallel to the motion damping means (15); the second rack means (22) is equipped with a connection means (23) engaged to, or matching with the mobile portion (17) of the motion damping means (15) to move the mobile portion (17) in the terminal portion of the closing stroke; the first pinion means (21) is fixed to a transmission shaft (24) connected to the first connection means (3) in a freely rotatable manner around a first pinion axis wherein the transmission shaft (24) is fixed a second pinion means (25) engaged to the second rack means (22); wherein the motion damping means (15) lies on a rotation plane of the second connection means (5) and the motion damping means (15) is oriented in parallel with respect to the second connection means (5) in the closed condition.

2) The device according to claim 1, further comprising a resilient means (18) acting in a detach direction between the fixed portion (16) and the mobile portion (17) of the motion damping means (15) so as to effect an elastic return of the mobile portion (17) into a rest condition.

3) The device according to claim 1, wherein the first pinion means (21) is fixed to a respective rotation pin (26) connected to the first connection means (3) in a freely rotatable manner around a rotation pin axis, and the first pinion means is engaged to the second rack means (22).

4) The device according to claim 3, wherein the first pinion means (21) is fixed to a respective rotation pin (26) and it is engaged to a third pinion means (27) fixed to a respective rotation pin (28) parallel to the pin of the first pinion means and connected to the first connection means (3); said third pinion means (27) is engaged with the second rack means (22).

5) The device according to claim 1, wherein the motion damping means (15) lying on the rotation plane of the second connection means (5) is orthogonally oriented in respect to the latter in the closed condition.

6) The device according to claim 1, wherein the first rack means (9) comprises a toothed sector and an elongated protrusion assigned to match with the portion (11) of the second connection means (5) and aligned to the toothed sector; and wherein the first guide means (10) comprise at least one among the first elongated buttonhole (30) obtained in the first connection means (3) aligned with the direction of sliding motion of the first rack means (9) and slidably engaged by a plurality of slide pins (31) fixed to the first rack means (9); tubular means (33) formed in or secured to the first connection means (3), having an internal cavity aligned with the sliding direction of the first rack means (9) and slidably engaged with an elongated protrusion of the first rack means (9).

7) The device according to claim 1, wherein the motion damping means (15) is at least partially housed in a box-shaped portion of the first connection means (3).
